(19) United States
(12) Patent Application Publication
(10) Pub. No.: US 2012/0320631 A1
(43) Pub. Date: Dec. 20, 2012

(54) COVER AND LIGHT GUIDE PLATE FOR ELECTRONIC DEVICE

(75) Inventors: NAI-LIN YANG, Shindian (TW); HAI-BO LI, Shenzhen City (CN); WEI GONG, Shenzhen City (CN); MIN ZHUO, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/327,477

(22) Filed: Dec. 15, 2011

(30) Foreign Application Priority Data
Jun. 17, 2011 (CN) 201120205377.2

(51) Int. Cl. F21V 8/00

(52) U.S. Cl. 362/629; 362/615

(57) ABSTRACT

A cover includes a molded cover body and a light guide board molded so as to be integral with the cover body. The cover body defines a mounting hole for mounting a keypad or keyboard.

### BACKGROUND

1. Technical Field

The disclosure generally relates to covers for electronic devices.

2. Description of the Related Art

Electronic devices (e.g. mobile phones) may include a front cover and a light guide plate (LGP). The LGP may be manually mounted on the front cover by latches. However, latches are fragile and liable to break and the manual mounting is time-consuming, nor is the assembled electronic device as structurally strong as it could be.

Therefore, there is room for improvement within the art.

### BRIEF DESCRIPTION OF THE DRAWINGS

Many aspects of the exemplary cover for electronic device can be better understood with reference to the following drawings. The components in the various drawings are not necessarily drawn to scale, the emphasis instead being placed upon clearly illustrating the principles of the exemplary cover for electronic device. Moreover, in the drawings, like reference numerals designate corresponding parts throughout the diagrams.

FIG. 1 is an isometric view of an electronic device according to an exemplary embodiment.

FIG. 2 is an isometric view of a cover used in the electronic device shown in FIG. 1.

FIG. 3 is a cross-sectional view of the electronic device in FIG. 1, taken along line III-III.

### DETAILED DESCRIPTION

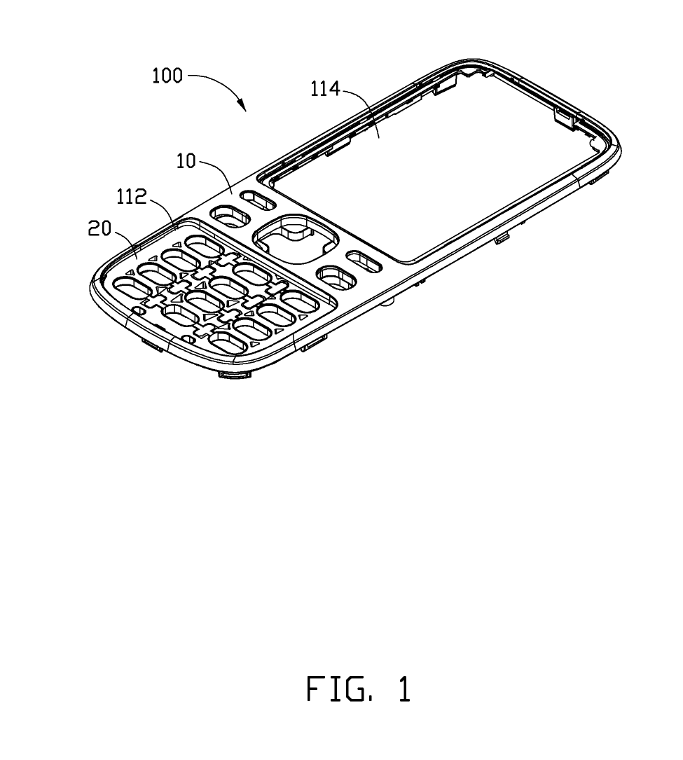

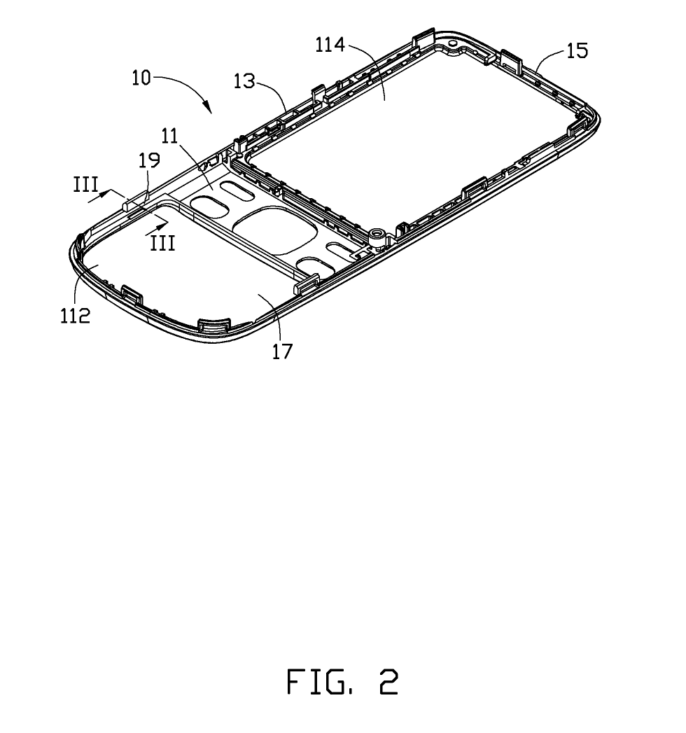

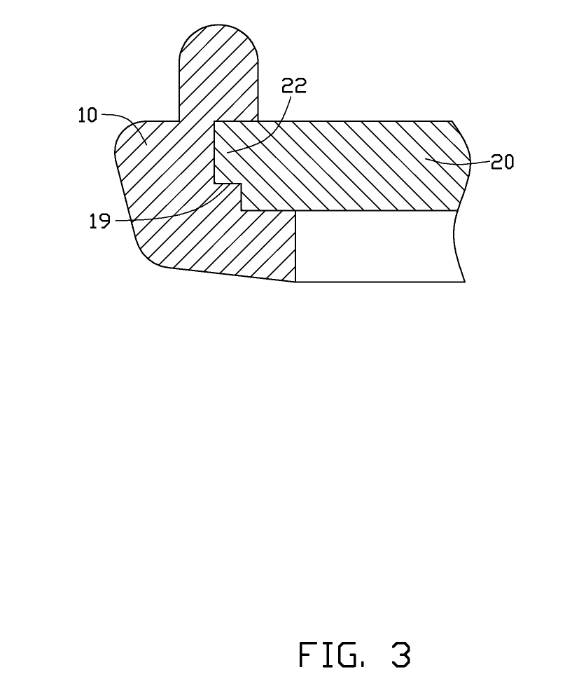

FIGS. 1-3 show an exemplary cover 100 for an electronic device. The cover 100 includes a cover body 10 (e.g. a front cover) and a light guide board (LGB) 20 molded with the cover body 10.

The cover body 10 includes a bottom wall 11, two opposite side walls 13 and two opposite end walls 15. The bottom wall 11, the side walls 13 and the end walls 15 cooperatively define a retaining slot 17. The bottom wall 11 defines a first mounting hole 112 and a second mounting hole 114. The first mounting hole 112 is for mounting a keypad or keyboard, and the second mounting hole 114 is for mounting a display. The first mounting hole 112 is located near one of the end walls 15, and the second mounting hole 114 is located near the other end wall 15. The side walls 13 and the end walls 15 are located around the first mounting hole 112, and defines fixing slots 19 for fixing the LGB 20 on the cover body 10. The fixing slots 19 face the retaining slot 17.

The LGB 20 is molded in the retaining slot 17 and covers the first mounting hole 112. The LGB 20 has fixing portions 22 projecting at the periphery. Each fixing portion 22 is molded into a fixing slot 19 to reinforce the mounting of the LGB 20 on the cover body 10.

The cover body 10 may be molded from thermosetting plastic being one or more materials selected from a group consisting of polyethylene, polyvinyl alcohol, polypropylene, polycarbonate, polymethyl methacrylate, acrylonitrile butadiene styrene, and polystyrene.

The LGB 20 may be made of transparent or semi-transparent thermosetting material, such as one selected from a group consisting of polycarbonate, polymethyl methacrylate, acrylonitrile butadiene styrene, and polystyrene.

A method for making the cover 100 may include the following steps:

A first injection molding machine is provided to make the cover body 10. The first injection molding machine includes a first molding chamber. Molten thermosetting material is injected into the first molding chamber to form the cover body 10.

A second injection molding machine is provided, to provide the LGP 20 made integrally with the cover body 10. The second injection molding machine includes a second molding chamber. The cover body 10 is positioned in the second molding chamber. Molten thermosetting rubber is injected into the second molding chamber to form the LGB 20 on the cover body 10. In this case the cover 100 has been made.

The LGB 20 is molded on the cover body 10, and the LGB 20 covers the first mounting hole 112. Therefore, the part of the cover 100 in which the first mounting hole is defined is strengthened.

It is to be understood, however, that even though numerous characteristics and advantages of the exemplary disclosure have been set forth in the foregoing description, together with details of the system and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A cover for an electronic device, comprising:
a molded cover body; and
a light guide board molded with the cover body,
wherein the cover body defines a mounting hole for mounting a keyboard or keypad of an electronic device, and the light guide board covers the mounting hole.

2. The cover as claimed in claim 1, wherein the cover body defines fixing slots, the light guide board comprises fixing portions, and each fixing portion is molded in the corresponding fixing slot.

3. The cover as claimed in claim 2, wherein the cover body comprises a bottom wall, two opposite side walls and two opposite end walls, the bottom wall, side walls and the end walls cooperatively define a retaining slot, the mounting hole is defined in the bottom wall, the fixing slots are defined in the side walls and end walls, and located around the mounting hole.

4. The cover as claimed in claim 1, wherein the cover body is molded from thermosetting plastic.

5. The cover as claimed in claim 4, wherein the thermosetting plastic is one or more selected from a group of polyethylene, polyvinyl alcohol, polypropylene, polycarbonate, polymethyl methacrylate, acrylonitrile butadiene styrene, and polystyrene.

6. The cover as claimed in claim 1, wherein the light guide board is molded from transparent or semi-transparent thermosetting material.

7. The cover as claimed in claim 6, wherein the transparent or semi-opaque thermosetting material is one selected from a group of polycarbonate, polymethyl methacrylate, acrylonitrile butadiene styrene, and polystyrene.
